(19) United States
(12) Patent Application Publication
(10) Pub. No.: US 2024/0216817 A1
(43) Pub. Date: Jul. 4, 2024

(54) EDUCATIONAL GAMING SOFTWARE

(71) Applicant: Habitheque, Pipersville, PA (US)

(72) Inventor: Victoria Prizzia, Pipersville, PA (US)

(73) Assignee: Habitheque, Pipersville, PA (US)

(21) Appl. No.: 18/432,118

(22) Filed: Feb. 5, 2024

Related U.S. Application Data
(63) Continuation-in-part of application No. 18/106,508, filed on Feb. 7, 2023.
Application No. 18/106,508 is a continuation of application No. 17/376,373, filed on Jul. 15, 2021, now Pat. No. 11,617,958.
(60) Provisional application No. 63/053,062, filed on Jul. 17, 2020.

(51) Int. Cl. A63F 13/67; A63F 13/798; A63F 13/822

(52) U.S. Cl. CPC A63F 13/67; A63F 13/798; A63F 13/822; A63F 2300/558; A63F 2300/6027; A63F 2300/807

(57) ABSTRACT

An educational game on a computing device is provided to a learner. Tasks are determined that are designed to advance educational skill of the learner. The educational skill may be in a field of science related to biological entities. A digital world display of a gaming realm associated with the educational game is provided to the computing device. The gaming realm may have an ecology inclusive of biological entities. A character controlled by the user is central to gameplay in the gaming realm. Changes, such as those made to the ecology of the gaming realm, occur responsive to the interaction between the character and the gaming realm. These changes and interactions may successfully or unsuccessfully complete the determined educational tasks. Confirmation of advancements in the educational skill level, via successful completion of the educational tasks, permit gameplay to advance beyond what was possible prior to confirmation of the educational advancement.

### CROSS-REFERENCE TO RELATED APPLICATIONS SECTION

This application is a Continuation-in-Part patent application that claims priority to U.S. Non-Provisional patent application Ser. No. 18/106,508 entitled Educational Gaming Software filed Feb. 7, 2023, which claims priority to U.S. Non-Provisional patent application Ser. No. 17/376,373 entitled Educational Gaming Software filed Jul. 15, 2021 issued as U.S. Pat. No. 11,617,958, which claims priority to U.S. Provisional Patent Application Ser. 63/053,062 filed on Jul. 17, 2020, the entire contents of all of which are hereby incorporated by reference as if fully set forth herein.

### FIELD OF THE EMBODIMENTS

The field of the invention and its embodiments relate to systems for motivating students to achieve educational goals. More specifically, the field of the invention and its embodiments relate to systems for motivating students to achieve educational goals through use of an educational game that presents a computer-generated gameplay digital world, where acquiring and demonstrating mastery of educational skills is a requirement for advancement of a character, associated with the learner, in the game.

### BACKGROUND OF THE EMBODIMENTS

Computerized gaming has become a popular form of entertainment. Many computerized games provide a virtual or digital world with the player assuming the role of a character interacting with other characters, objects, or locations in an attempt to accomplish a series of tasks leading to an overall goal. Computerized gaming may be played on a variety of hardware platforms, from specialized individual computer gaming devices to games played with a general-purpose PC on a website on the Internet. Games that create elaborate virtual worlds and allow multiple players to inhabit these worlds are often known as massively multiplayer online role-playing games. Other applicable games are often categorized as world builder games, adventuring games, and first-person shooter games. Some of these games may be played using the Internet, possibly in interactive cooperation with others in real-time.

A problem exists to motivate students to acquire educational skills outside of the required classroom hours of one's education program. Though individuals frequently engage in computerized gaming, most of these games fail to provide an educational aspect to foster student learning. More specifically, computerized gaming fails to provide education regarding environmental awareness and sustainable resource protection. Additionally, computerized gaming fails to provide education regarding natural water systems.

There is a need for a computerized game that users find desirable to play, which integrates means to acquire educational skills or knowledge (such as knowledge regarding environmental awareness and sustainable resource protection). There is also a need for a computerized game that provides valuable entertainment to the masses.

### REVIEW OF RELATED TECHNOLOGY

U.S. Pat. No. 7,402,105 B1 and U.S. Pat. No. 8,016,680 B1 relate to a massively multiplayer educational online game. The game presents a computer-generated gameplay world where acquiring and demonstrating mastery of educational skills is a requirement for survival and advancement of a learner's game character. The game also provides a method for effectively teaching a set of target educational skills by motivating the learner to improve understanding of the skills by having to demonstrate the skills as part of the game.

U.S. Published Patent Application No. 2002/0043761 A1 relates to a computerized educational game. The educational game includes an interactive journey or mission that provides educational experiences for one or more players related to a subject, such as science, history, social science, geography, agriculture, space exploration, etc.

U.S. Published Patent Application No. 2007/0281285 A1 relates to an interactive educational game that includes adventure storylines in which a player advances, scores points, or wins by correctly answering educational challenges posed throughout the game. The game gauges and dynamically adjusts a player's skill and knowledge level for a particular subject (e.g., math, grammar, spelling, science, etc.) to tailor the challenges and/or speed of the game accordingly. As the game progresses, it monitors the player's progress in terms of skill and/or knowledge level and dynamically adjusts the type and/or difficulty of the questions to challenge the player.

U.S. Pat. No. 9,205,329 B2 relates to a virtual world electronic game that is educational.

U.S. Published Patent Application No. 2014/0024464 A1 describes a massively multiplayer online strategic and multipurpose educational game.

U.S. Published Patent Application No. 2005/0200078 A1 relates to an educational science game that encourages learning, while providing a novel and unique gaming experience. An array of unusual or unique features are combined in the game, such as the ability to move any game piece along a primary and a secondary game board, variable movement for different game pieces depending upon the characteristics of that game piece, the ability to obtain “equipment” to alter those characteristics, and an ultimate goal based upon the acquisition of a plurality of tokens.

U.S. Published Patent Application No. 2017/0209779 A1 describes an apparatus for providing an entertaining environment that balances the “work” and “fun” attributes of an activity so as to promote knowledge accumulation and learning in numerous fields, such as: history, art, and science (e.g., natural sciences, social sciences, human philosophy, psychology, engineering, medicine, physics, electronics, etc.), among others.

U.S. Published Patent Application No. 2013/0217453 A1 describes an educational multi-media interactive play system that has a number of play elements situated in a variety of play environments. The play elements are linked to a common record of participant performance, progress, character attributes, etc. The participant's performance in the play elements determines the play elements to which the participant may proceed, as well as the play parameters of the play element in which the participant is currently involved. The play elements are thus interlinked to define a sequence or path network along which the participant advances. By advancing through the play elements, the participant carries out a plot, story, theme, etc. that attaches a significance to the successful completion of a given play element or elements.

Various educational teaching tools and games exist in the art. However, their means of operation are substantially different from the present disclosure, as the other inventions fail to solve all the problems taught by the present disclosure.

### SUMMARY OF THE EMBODIMENTS

The present invention and its embodiments relate to systems for motivating students to achieve educational goals. More specifically, the present invention and its embodiments relate to systems for motivating students to achieve educational goals through use of an online multiplayer simulation game that presents a computer-generated gameplay virtual world, where acquiring and demonstrating mastery of educational skills is a requirement for advancement of a character, associated with the learner, in the game.

A first embodiment of the present invention describes a method of providing an online multiplayer educational game to a learner from a server. In examples, the online multiplayer educational game is a science fiction game. The method includes: detecting a connection of a computing device associated with a learner to a server, providing a virtual world display of a gaming realm associated with the online multiplayer educational game to the computing device of the learner, and allowing the learner to utilize a controller to manage functions of the gaming realm.

The virtual world comprises at least three locations, where a first location of the at least three locations comprises quadrants. Each of the quadrants includes a pod and resources. In examples, the pod in each of the quadrants differs. Further, the pod comprises plant species and/or animal species. The method may also include presenting, via the gaming realm, the pod to the learner when the learner enters the quadrant and encounters the pod or randomly presenting, via the gaming realm, the pod to the learner as the learner advances through the online multiplayer educational game as the character.

The method may further include providing, via the gaming realm, the learner with a character (e.g., an animal) such that the learner controls the character. The learner may also be provided with a vehicle for the learner to advance through the online multiplayer educational game as the character. In examples, the vehicle is a spacecraft.

The method may additionally include providing, via the gaming realm, at least two crew members and another animal to the learner to assist the learner in completing tasks during gameplay. A manifestation of the other animal in the gaming realm is correlated to actions of the learner as the learner advances through the online multiplayer educational game as the character.

The method may also include, via the gaming realm, providing training tasks associated with an educational skill, detecting a successful demonstration of the training tasks associated with the educational skill, and providing mastery tasks associated with the educational skills. The method may further include, via the gaming realm, detecting a successful demonstration of the mastery tasks associated with the educational skill, allowing the learner to advance through the online multiplayer educational game as the character, modifying one or more components in the gaming realm, and updating a learner profile to reflect a successful completion of the mastery tasks associated with the educational skill.

The modification of the one or more components in the gaming realm may include: adding components to the vehicle, enhancing an efficiency of the vehicle, upgrading the vehicle, allowing the learner to add the plant species and/or the animal species from the pod into the vehicle, allowing the learner to add the resources from each of the quadrants into the vehicle, adding a function of the gaming realm to the controller, and allowing the learner to add acquired resources, plant species, and/or animal species into a dwelling associated with a second location of the at least three locations located in the virtual world.

The method may additionally include detecting a failure, via the gaming realm, to demonstrate the mastery tasks associated with the educational skill. In response to this detection, the learner may be provided feedback and the learner profile may be updated to reflect an unsuccessful completion of the mastery tasks associated with the educational skill.

A second embodiment of the present invention describes a method of providing an educational game to a learner from a server. A connection of a computing device associated with a learner is detected by a server. The server can retrieve a current level of educational skill of the learner. The server determines a target level of educational skill of the learner. The server determines one or more training tasks designed to advance the current level of educational skill of the learner to a target level. The server determines one or more mastery tasks designed to confirm the target level of educational skill has been achieved by the learner. A digital world display of a gaming realm associated with the educational game is provided to the computing device of the learner. Via the gaming realm, the learner is provided with a character such that the learner controls actions of the character within the gaming realm. The character progressing through the gaming realm includes one or more locked milestones, such that a first milestone must be unlocked prior to progression to a second milestone being enabled. Unlocking the first milestone requires the learner to achieve the target level of educational skill. Via the gaming realm, the determined one or more training tasks are provided. In response to detecting, via the gaming realm, a successful demonstration of the training tasks associated with the educational skill, the mastery tasks are provided. In response to detecting, via the gaming realm, a successful demonstration of the mastery tasks associated with the educational skill, the first milestone is unlocked. The unlocking permits the learner to process in the gaming realm towards the second milestone. The server updates the current level of the learner to the target level of educational skill.

A third embodiment of the present invention describes a method of providing an educational game to a learner. A computing device associated with a learner is detected. A target level of educational skill of the learner is determined. One or more training tasks designed to advance the learner to the target level are determined. A digital world display of a gaming realm associated with the educational game is provided to the computing device of the learner. Via the gaming realm, the learner is provided with a character such that the learner controls actions of the character within the gaming realm. The gaming realm within which the character interacts can include one or more biological entities. A biological entity can be an animal or plant for example. The educational skill is in a field of science related to the biological entities, such as biology. Other related sciences can include chemistry, physics, geology, genetics, evolution, environmental sciences, and the like. The training tasks involve interactions between the character and the gaming realm that are scientifically targeted to said field of science and corresponding educational skill. For example, gameplay can includes essences that are presented as rewards when a gameplay ecology is improved through character actions. Via the gaming realm, the learner is presented with a character such that the learner controls actions of the character in gameplay in a manner resulting in satisfaction of the training tasks. For example, world building tasks, such as raising a set of animals can advance training tasks of animal husbandry. In another example, a chemistry task of detecting a pollutant within an ecosystem can be a necessary step to improving health of animal companions, which assist the character during gameplay. Training tasks and educational skills can be customized for a given learner, which results in customized gameplay advancement. Responsive to satisfaction of the training tasks, the server records that the learner has reached the target level of educational skill. Responsive to the satisfaction of the training tasks, a previously locked aspect of gameplay within the gaming realm can be unlocked, thereby permitting the character to advance in the gameplay.

A fourth embodiment of the present invention describes another method of providing an educational game to a learner. A computing device associated with a learner is detected. One or more educational tasks designed to advance an educational skill of the learner are determined. A digital world display of a gaming realm associated with the educational game is provided to the computing device of the learner. The gaming realm has a gaming realm ecology that includes biological entities, such as plants and animals.

Essences are utilized in one contemplated implementation that relates to both educational achievements and to gameplay advancement. In one embodiment, plants can generate essences that permit the animals to grow and/or that permit the character to power-up. In another embodiment, essences can be substances, such as fertilizer for plants, that increase the health of plants, animals, or the character. Essences, when used, may accumulate during gameplay and may be used as “coins” for purchase of in-game items. Essences may also be used to evolve an animal from one level to another. Ecosystem establishment, improvement, and maintenance can be linked to essences in embodiments, such that complex dependencies of ecosystems can be modeled or simplified through the use of essences.

Via the gaming realm, the learner is provided with a character such that the learner utilizes the character to interact with the gaming realm. The interactions occur during gameplay and affect the gaming realm ecology and related aspects of the biological entities. The educational skill is in a field of science related to the one or more biological entities. Changes to the gaming realm ecology occur in a manner that advances the educational skill level of the learner. Responsive to a gameplay interaction of the character that positively affects the gaming realm ecology while concurrently advancing the educational skill level, a quantity or quality of one or more animals is increased. The character utilizes the improved animal(s) in gameplay. Powerful or improved animals positively advance the gameplay of the learner.

In general, the present invention succeeds in conferring the following benefits and objectives.

It is an objective of the present invention to provide an educational game that motivates the user/player to acquire educational skills.

It is an objective of the present invention to provide an online multiplayer simulation game.

It is an objective of the present invention to provide an online multiplayer simulation game that is science-fiction based.

It is an objective of the present invention to provide an online multiplayer simulation game that is science-fiction based and provides science-based content for learning purposes (including environmental awareness and sustainable resource protection).

### BRIEF DESCRIPTION OF THE DRAWINGS

FIG. 1 depicts a block diagram of a system of motivating success of a learner in educational skill practice when playing an online multiplayer simulation game, in accordance with embodiments of the present invention.

FIG. 2 depicts a block diagram of a method for a learner to connect to an online multiplayer simulation game, in accordance with embodiments of the present invention.

FIG. 3 depicts a block diagram of a method to teach educational skills to a learner when playing an online multiplayer simulation game, in accordance with embodiments of the present invention.

FIG. 4 depicts a schematic diagram of a controller utilized within a system of FIG. 1, in accordance with embodiments of the present invention.

FIG. 5 depicts a block diagram of a gaming realm of an online multiplayer simulation game, in accordance with embodiments of the present invention.

FIG. 6 depicts another block diagram of a gaming realm of an online multiplayer simulation game, in accordance with embodiments of the present invention.

FIG. 7 depicts a block diagram of a vehicle for use in a gaming realm associated with an online multiplayer simulation game, in accordance with embodiments of the present invention.

FIG. 8 depicts another block diagram of a gaming realm of an online multiplayer simulation game, in accordance with embodiments of the present invention.

FIG. 9 is a block diagram of a computing device, in accordance with embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, an “embodiment” means that a particular feature, structure or characteristic is included in at least one or more manifestations, examples, or implementations of this invention. Furthermore, the particular features, structures or characteristics may be combined in any suitable manner, as would be apparent to a person having ordinary skill in the art. Combinations of features of different embodiments are meant to be within the scope of the invention, without the need for explicitly describing every possible permutation by example. Thus, any of the claimed embodiments can be used in any combination.

The phrase “and/or,” as used herein in the specification and in the claims, should be understood to mean “either or both” of the elements so conjoined, e.g., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements), etc.

As used herein, the word “include,” and its variants, is intended to be non-limiting, such that recitation of items in a list is not to the exclusion of other like items that may also be useful in the compositions and methods of this technology. Similarly, the terms “can” and “may” and their variants are intended to be non-limiting, such that recitation that an embodiment can or may comprise certain elements or features does not exclude other embodiments of the present technology that do not contain those elements or features.

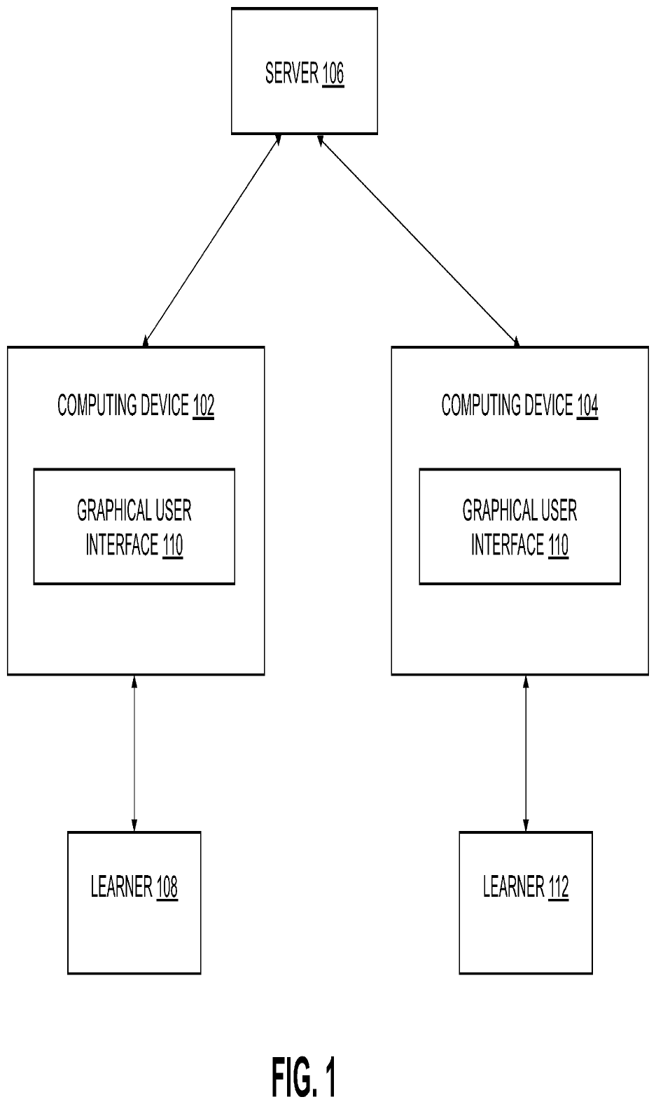

A system for educational game is depicted in FIG. 1. In embodiments, the educational game can be an online multiplayer simulation game. In embodiments and unlike traditional educational software, the disclosed educational game can inherently integrate aspects of learning within an application that the user perceives as a purely entertainment experience. That is, the educational game can be a commercial game with robust game mechanics, where educational content is intentionally seamless, integrated throughout gameplay in a significant way without disrupting or diminishing the game experience for the player, thus being more accessible to all types of learners and game players than traditional learning games. In embodiments, the educational game can be a role playing game, an adventure game, and exploration game, a world-building game, a virtual reality game, a first-person shooter game, and the like. In one embodiment, the game itself can include an ecosystem, having a health affecting gameplay. The game itself is for entertainment purposes, yet it may include inherent educational aspects that affect gameplay. In embodiments, the game is tailored for educational skill levels of the user, who is often referred to herein as the learner. It should be appreciated that in some examples, the online multiplayer simulation game described herein is a storytelling platform. In other examples, the game described herein is a science fiction game, which leverages scientific facts and learning during gameplay interactions. In further examples, online multiplayer simulation game described herein is a science fiction-based game that provides science-based content for learning purposes (including environmental awareness and sustainable resource protection; ecology for organisms in their physical surroundings; biology for growth and leveling of in-game living beings; physical sciences and outer space; evolutionary and generic factors related to in-game entities; and the like). In another example, the online multiplayer simulation game described herein may be a science-fiction online multiplayer simulation game set in a parallel universe where otters are the predominant species.

In embodiments, the gameplay may integrate one or more recognizable US agencies, organizations, and companies. Further, partnerships and interactive opportunities may be established between the game owner (or gaming platform) and the respective agencies, organizations, and companies that are not only mutually beneficial but also educational and fun. For example, the U.S. Environmental Protection Agency (EPA) may be expressly interacted with during gameplay, where gameplay goals and learning achievement are linked to the EPA. In one embodiment, an in-game digital award, such as EPA Warrier, EPA Gold Metalist, is granted based on in-game actions consistent with improving the virtual environment. In another embodiment, achievement recipients could be noted on an official EPA website. In still another embodiment, gameplay can earn a player a physical or printable certificate from the EPA responsive to completion of in-game milestones. In another embodiment, a partnership may exist with a local zoo proximate to the player, such that in game activity can earn a free zoo visit or zoo discount.

In still another embodiment, an in game acknowledge/interaction with the National Aeronautics and Space Administration (NASA) may occur. In such a scenario, NASA may be conducting an outreach to game players, which may confer a benefit to the game player themselves or to the gaming platform. For example, a cross-marketing strategy can provide positive advertisement to NASA, which in turn provides a level of advantageous advertising for the gaming platform. In one embodiment, within the gaming platform, images of items in space obtained by NASA can be situationally presented during gameplay along with NASA curated facts.

NASA is a particular agency or partner of interest, as NASA innovates for the benefit of humanity and improves life on Earth through climate research and technological innovations. NASA's vantage point from space provides critical information to advance understanding of our changing planet to benefit humanity, including impacts from greenhouse gas emissions, the effect of warming including glacier and ice sheet melt, heat waves, rising sea levels, intense precipitation, and shifting animal migration patterns. Thus, integration efforts or game partnerships with an entity like NASA, furthers NASA's goals through a positive outreach to a set of game players. These players may be resistant to traditional outreaches, yet receptive to those presented within intentionally seamless gameplay. Concurrently, NASA may interact with the gaming platform, behind the scenes, to accurately integrate climate drivers and solutions that are explored throughout game play in the characters and challenges of the game itself. The system of FIG. 1 may include a first computing device 102 associated with a first learner 108 (e.g., a first user), a second computing device 104 associated with a second learner 112 (e.g., a second user), and a server 106. In single player scenarios, the second computing device 104 may not be utilized. In multi-player ones, the first and second computing devices 102, 104 can interact with a gaming realm and with each other in real-time. Each of the first computing device 102 and the second computing device 104 may be a desktop computer, a laptop computer, a smartphone (e.g., an iPhone®, a Blackberry®, or an Android OS-based phone, etc.), a cellular telephone, a tablet computer (e.g., an Apple iPad™, an HP Slate™, or a Motorola Xoom™, etc.), or an eBook reader (e.g., an Amazon Kindle™ or Barnes and Noble's Nook™ eReader, etc.), among other examples not explicitly listed herein. Each of the first learner 108 and the second learner 112 may be individuals capable to operate such computer device, and therefore, can include pre-kindergarten aged individuals. Other age groups and learning targets, such as grade-school, middle-school, high-school, and even college can be targeted. In one embodiment, gameplay can be integrated with a curriculum, such that gameplay learning achievements result in bonus points in a related class that a learner 108, 112 is taking.

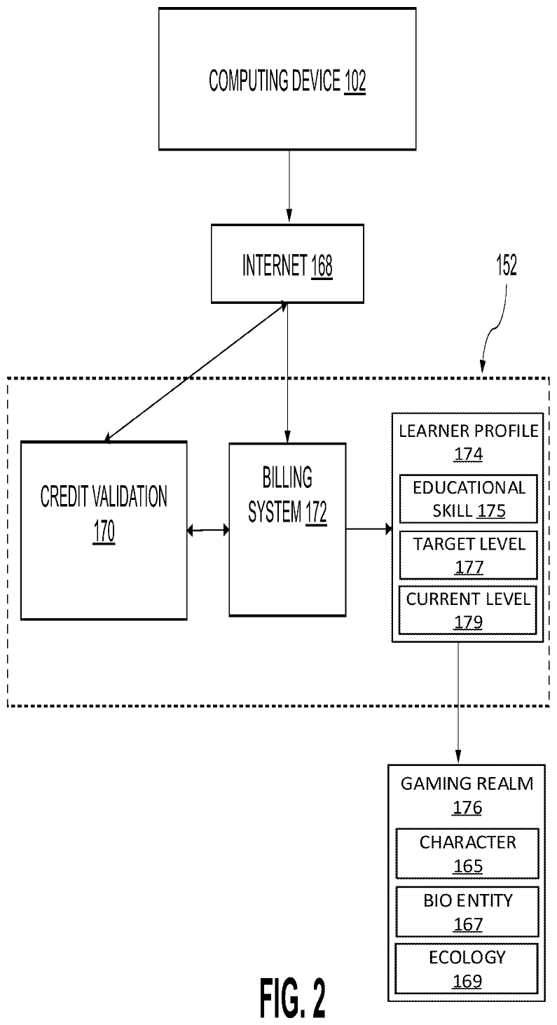

The first learner 108 may interact with the first computing device 102 and the second learner 112 may interact with the second computing device 104 via a graphical user interface (GUI) 110 on the first computing device 102 and the second computing device 104, respectively. It should be appreciated that the online multiplayer simulation game may be played by a singular user during a given time period, such as the first learner 108. In other examples, the online multiplayer simulation game may be played by multiple users during the given time period, such as the first learner 108 and the second learner 112. The quantity of users engaging with the online multiplayer simulation game is non-limiting. The first learner 108 may access the online multiplayer simulation game via the first computing device 102 by connecting to the server 106, such as on the Internet 168 (of FIG. 2). Similarly, the second learner 112 may access the online multiplayer simulation game via the second computing device 104 by connecting to the server 106, such as on the Internet 168.

As shown in FIG. 2, the learner (e.g., the first learner 108) may be provided access to a gaming realm 176 associated with the online multiplayer simulation game. The gaming realm 176 serves as a social world framework to provide motivation for inducing frequent gameplay. According to FIG. 2, the learner (e.g., the first learner 108) may use an Internet connected computing device (e.g., the first computing device 102) for access to a connection 152. The connection 152 may be a web portal of the Internet 168, a wireless network with Internet 168 capability, or a dedicated network, such as one found in an educational institute.

The gaming realm 176 includes one or more characters 176 controlled by the learner 108, 112. Further, the gaming realm 176 can include one or more biological entities 167, with which the character 165 interacts. Biological entities 167 include plants and animals. Biological entities 167 can be part of a defined gaming realm ecology 169, which is significant to both gameplay and educational goals presented herein. For example, a character 165 can obtain and evolve a set of animals (167) that assist with gameplay goals. Maintaining the health of companion animals may require maintenance, such as feeding, which can occur through the consumption of plants (167) and other animals, each of which are part of the ecology that is maintained by character 165 actions. Thus, by interacting in the gaming realm 176, the user is learning about ecology due to the relationship of biological entities 167 and their surroundings. Other learning opportunities in fields such as biology, genetics, evolution, animal husbandry, health, nutrition, and the like are contemplated and can be integrated in embodiments of the innovation. Further, these learning opportunities can be presented at different times and levels, which are dependent upon a learning profile and a set of goals established for the learner 108.

The connection 152 contains a billing system 172 that verifies a payment status of an account associated with the first learner 108. The connection 152 also includes a credit validation engine 170 that verifies/validates a credit of the first learner 108, if a new account. Depending on the mode of operation, the account associated with the first learner 108 is charged on a periodic basis to maintain access to the online multiplayer simulation game. Furthermore, the online multiplayer simulation game described herein will allow the learner (e.g., the first learner 108) to make In-Game Purchases (IGPs). Each IGP may be verified via the billing system 172 and may be channeled and donated to one or more environmental causes. In one embodiment, the billing system 172 can accept payments at least in part from an educational institution that the learner 108, 112 attends. The connection 152 also contains a learner profile 174 associated with the first learner 108 that may be updated to log the access to the gaming realm 176 and updated periodically as gameplay continues.

In some examples, the online multiplayer simulation game may include a communication component (not shown) in an in-game information center, allowing the learner (e.g., the first learner 108) to view, read, and study real-life scientific research. Further, gameplay objects, such as biological entities, can be linked to an online catalog providing educational information helpful for resolving gameplay tasks.

In one embodiment, each learner 108, 112 has their own established learner profile 174, within which a level of educational skill 175 is determined and/or recorded. Educational skills 175 can be defined at a quantized level and segmented into different educational areas. For example, educational skill 175 levels can be established within the profile 174 for knowledge in biology, ecosystems, space, geology, geography, mechanics, physics and the like. A learner's 108, 112 current level 179 in each of the educational skills 175 can be determined, maintained, and updated within the learner profile 174. Furthermore, each educational skill 175 can have an associated target level 177, which is greater than the current level 179.

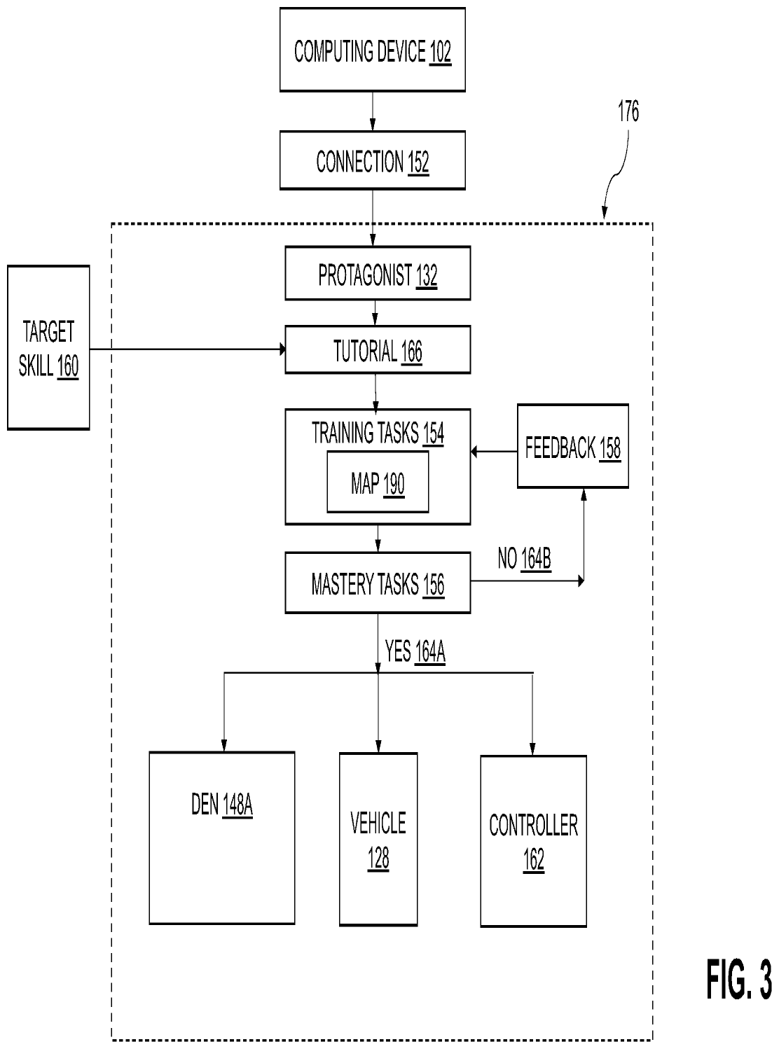

A block diagram of a method to teach educational skills (such as a specific target level of an education skill shown as target skill 160) to the learner (e.g., the first learner 108) is depicted in FIG. 3. In some examples, the target skill 160 includes learning the science behind water, learning about environmental awareness, and/or learning about sustainable resource protection, among others. As noted, the target skill 160 can relate to an ecology 169 of the gaming realm 176 that changes based on character 175 interactions. As explained, the learner (e.g., the first learner 108) uses a computer or other gaming device (e.g., the first computing device 102) capable of receiving the learner's input to the online multiplayer simulation game via the GUI 110 and capable of displaying content of the gaming realm 176 to the learner (e.g., the first learner 108). The first computing device 102 is connected to the gaming realm 176 via the connection 152, as shown in FIG. 3.

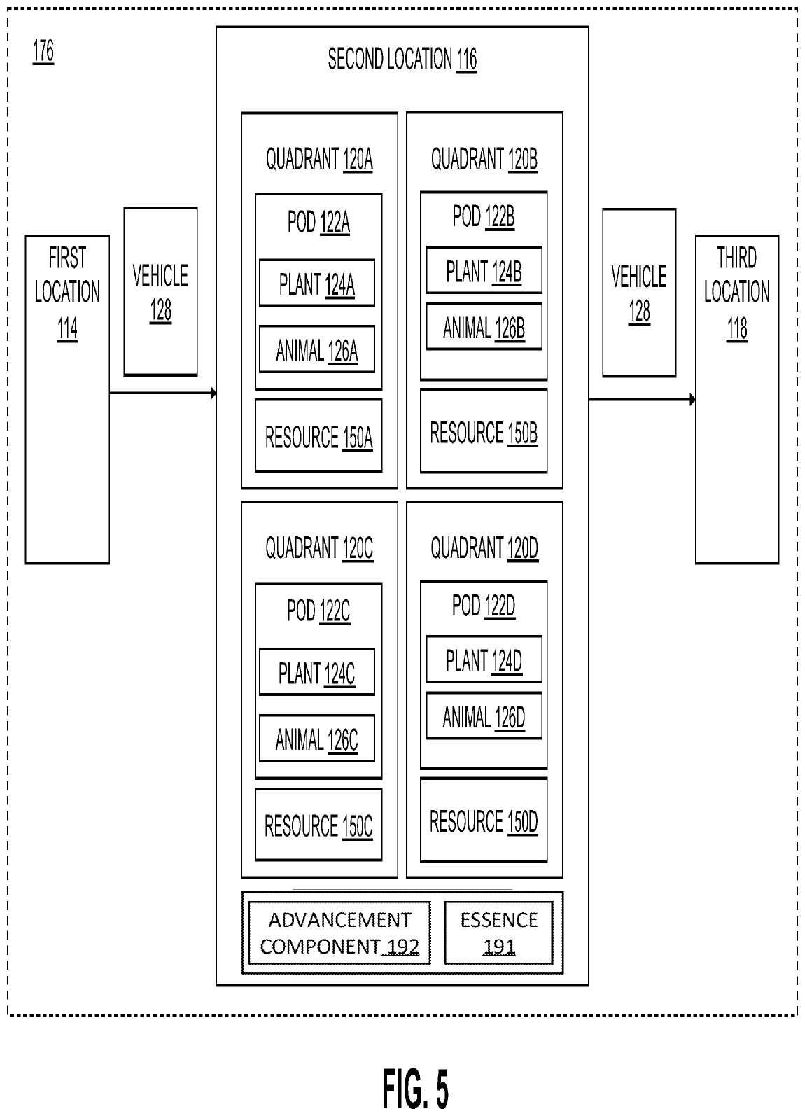

A virtual world display of the gaming realm 176 may be provided to the learner (e.g., the first learner 108) subsequent connecting the first computing device 102 to the gaming realm 176 via the connection 152. In some examples, the virtual world comprises at least three locations. The at least three locations may include a first location 114, a second location 116, and a third location 118, as shown in FIG. 5. In some examples, the first location 114 includes Earth, the second location 116 includes outer space, and the third location 118 includes a planet. One or more of the locations 114, 116, and 118 can be initially locked, which restricts the character from interacting with the locked location 114, 116, 118. Achievement of one or more educational target levels 177 signifying an increase in the related educational skill 175 can unlock an otherwise locked location 114, 116, 118.

In additional examples, the learner (e.g., the first learner 108) may be provided with a character 165 in the gaming realm 176 such that the learner (e.g., the first learner 108) controls the character 165. In examples, the character is a protagonist 132, as depicted in FIG. 3. In further examples, the protagonist 132 is an animal. Preferably, the protagonist 132 is an otter.

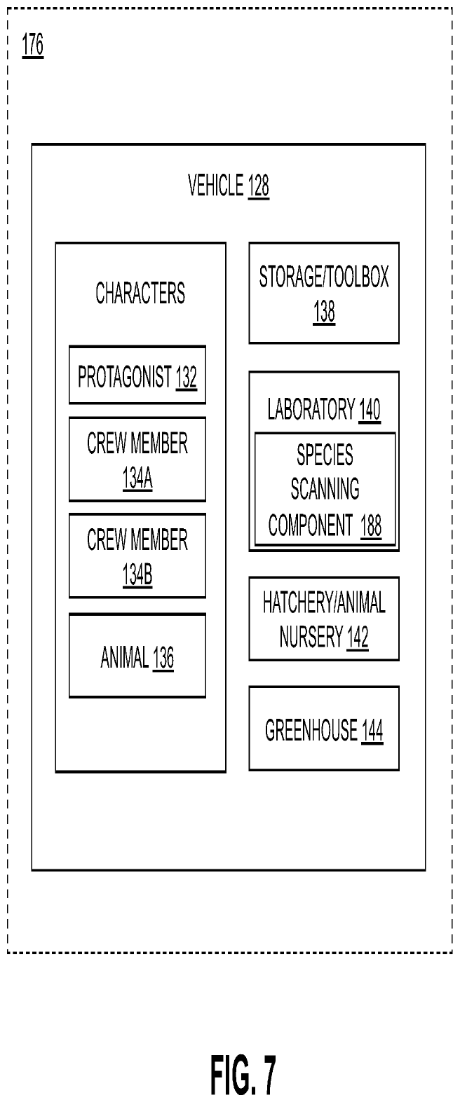

The learner (e.g., the first learner 108) may also be provided with a vehicle 128 (of FIG. 3, FIG. 5, and FIG. 7) for the learner (e.g., the first learner 108) to use to advance through the educational game as the character 165 (e.g., the protagonist 132). In some examples, the vehicle 128 is a spacecraft. In embodiments, advancement of the educational skill 175 to one or more target levels 177 may be necessary before the vehicle 128 is able to be utilized by the character 165.

In additional examples, and as depicted in FIG. 7, the vehicle 128 may comprise one or more rooms, such as a storage room/toolbox room 138 (to store resources, plant species, and/or animal species), a laboratory 140, a hatchery/animal nursery 142, and/or a greenhouse 144, among others not explicitly listed herein. When the learner (e.g., the first learner 108) enters a room of the one or more rooms in the vehicle 128, the room expands into its own scene.

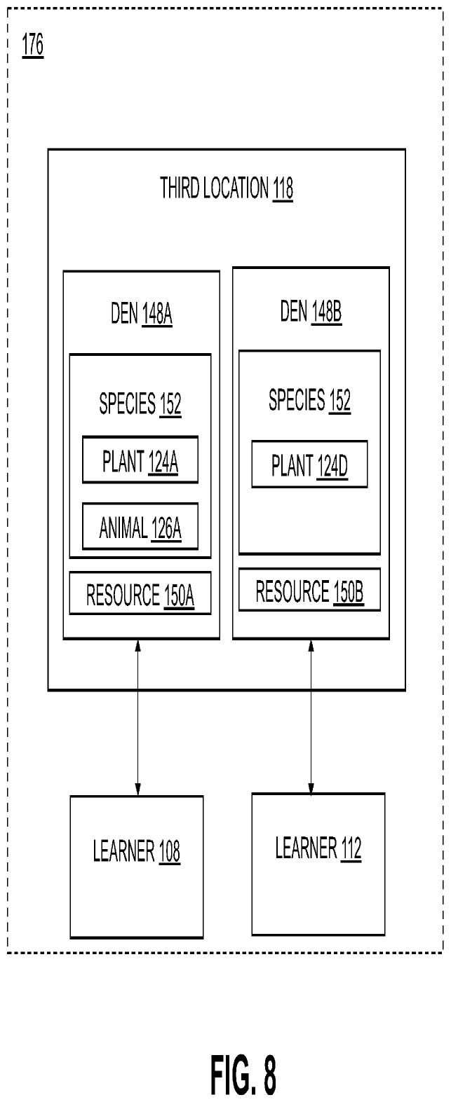

It should be appreciated that the vehicle 128 serves as an innovative incubator, allowing for the learner (e.g., the first learner 108) to engage in controlled experimentation and learning through use of the one or more rooms (such as the laboratory 140). The learner (e.g., the first learner 108) may also use the vehicle 128 if the learner (e.g., the first learner 108) needs to escape dangers during gameplay. All of the tools, resources, plant species, and/or animal species accumulated within the vehicle 128 are applied to the creation and management of a den/dwelling (such as a first den 148A and/or a second den 138B of FIG. 8) in the third location 118. For example, the hatchery/animal nursery 142 and/or the greenhouse 144 serve to create small populations of plant and/or animal species such that these species may be later introduced into a habitat of the den/dwelling (e.g., the first den 148A) in the third location 118 in response to natural ecosystem fluctuations and environmental disturbances on the third location 118.

In an illustrative example and as shown in FIG. 5, the learner (e.g., the first learner 108) may utilize the vehicle 128 to leave the first location 114 (e.g., Earth) upon detecting that this location is severely environmentally compromised and may traverse the second location 116 (e.g., outer space) in search of a portal to another location (e.g., the third location 118 or the planet) to start life anew.

Moreover, as shown in FIG. 7, the learner (e.g., the first learner 108) may be provided at least two crew members (e.g., a first crew member 134A and a second crew member 134B) and an animal 136 to the learner (e.g., the first learner 108) to assist the learner (e.g., the first learner 108) in completing training tasks during gameplay. The at least two crew members (e.g., the first crew member 134A and the second crew member 134B) and the animal 136 serve as primary allies and sources of support and assistance for the learner (e.g., the first learner 108) during gameplay. Specifically, the learner (e.g., the first learner 108) is assigned the animal 136 at a beginning of gameplay in response to providing answers to a series of questions.

In some examples, the animal 136 is a spirit animal where a manifestation of the spirit animal in the gaming realm 176 is correlated to actions of the learner (e.g., the first learner 108) as the learner (e.g., the first learner 108) advances through the game as the character (e.g., the protagonist 132). Such manifestation of the animal 136 may be visible in the appearance of the animal 136. Interaction of the learner (e.g., the first learner 108) with the animal 136 provides the narrative of the online multiplayer educational game.

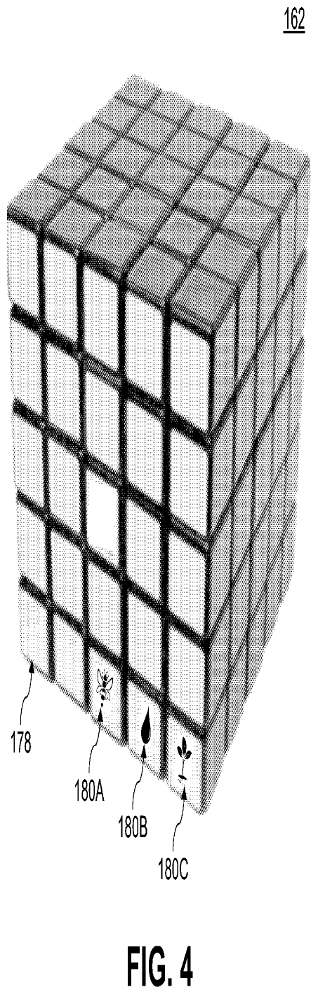

Moreover, the learner (e.g., the first learner 108) may be provided a controller 162 (of FIG. 3 and FIG. 4) to manage functions of the gaming realm 176. The controller 162 may include a plurality of squares 178 (of FIG. 4), where each of the squares 178 represents a function of the gaming realm 176. The functions of the gaming realm 176 may include accumulated skills, animal species cultivated, plant species cultivated, resources, and/or management strategies, among others not explicitly listed herein.

The controller 162 also functions as a control center that is constantly fluctuating during gameplay to represent changes in the vehicle 128, surrounding environs, a status of the first den 148A, environmental changes in the third location 118, etc. Controllable elements that impact the power supply, water quality, and sustainable food production are all monitored and displayed via the controller 162. The controller 162 also communicates an overall environmental health of the third location 118, including atmosphere, hydrosphere, lithosphere, and the interactions between the life forms present.

To elaborate, the controllable elements can be part of an ecology 169 that is able to be improved or harmed. Health of a related ecosystem inclusive of plants 124A and animals 126A are affected by how successfully a user applies the controllable elements. Reaching health thresholds of the ecosystem or ecology 169 can be linked different educational skills 175, current levels 179, and target levels 179 in embodiments. Educational skills 175 can target various learning subjects. In one embodiment, these subjects and learning goals may even be mapped to a curriculum or set of standards, such as those detailed in a Common Core curriculum. Many educational systems have national, state, local, or even company specific curriculum targets, any of which can be adapted to the learning and skills 175 present in aspects of the innovation.

In various embodiments, the concept of essence 191 can be used as an advancement component 192. That is, essence 191 may be a “coin” or financial instrument acquired and expended during gameplay. Advancement of power levels or evolution of the character 165, of an animal 126A, plant 124A, or ecology 169 may require quantities of essence 191. Essence 191 is not necessarily uniform and may be designed as different types. Established quantities of each type of essence 191 may be necessary for the evolution (advancement of levels) of specific types of biological entities 167. In one embodiment, the different types of essence 191 can be correlated to different educational skills 175, each with related (yet evolving as gameplay progresses) levels (current level 179 and target level 177). Satisfaction of a target level 177 may result is a significant reward of an associated essence 191.

As shown in FIG. 3, the learner (e.g., the first learner 108) may be provided with a tutorial 166 and/or training tasks 154 associated with the educational skill 160. The tutorial 166 and/or the training tasks 154 may be quests, projects, competitions, and/or jobs the character must complete. As an illustrative example, the training tasks 154 associated with the target educational skill 160 may require the learner (e.g., the first learner 108) to work with a map, such as a celestial skies map 190, during a journey traversing the outer space (e.g., the second location 116). In examples, the celestial skies map 190 is an interactive resource that provides the learner (e.g., the first learner 108) with information and knowledge. In such an example, the noted educational skill 175 and related target level 177 can be space or geography specific skill.

As explained, in some examples, the first location 114 includes the Earth, the second location 116 includes the outer space, and the third location 118 includes the planet. As shown in FIG. 5, the learner (e.g., the first learner 108) may utilize the vehicle 128 to leave the first location 114 (e.g., Earth) upon detecting that this location is severely environmentally compromised and may traverse the outer space (e.g., the second location 116) in search of a portal to the third location 118 or the planet. The learner (e.g., the first learner 108) may utilize the celestial skies map 190 and data collection tools along the journey. The learner (e.g., the first learner 108) may be tasked with finding the portal to the third location 118 or the planet before the vehicle 128 runs out of vital resources.

In additional examples, and as depicted in FIG. 5, the outer space (e.g., the second location 116) includes quadrants. The quadrants include a first quadrant 120A, a second quadrant 120B, a third quadrant 120C, and a fourth quadrant 120D, as shown in FIG. 5. Progression of the learner (e.g., the first learner 108) from one of the quadrants (e.g., the first quadrant 120A) to another quadrant (e.g., the second quadrant 120B) gives the learner (e.g., the first learner 108) opportunities and a sense of advancement. This sense of advancement can be linked to achievement of established target levels 177 for related ones of the educational skills 175.

During this journey, the learner (e.g., the first learner 108) may encounter pods and/or collect resources. Each of the first quadrant 120A, the second quadrant 120B, the third quadrant 120C, and the fourth quadrant 120D comprises a first pod 122A, a second pod 122B, a third pod 122C, and a fourth pod 122D, respectively. Further, each of the first quadrant 120A, the second quadrant 120B, the third quadrant 120C, and the fourth quadrant 120D comprise one or more resources (e.g., a first resource 150A, a second resource 150B, a third resource 150C, and a fourth resource 150D).

Each of the first pod 122A, the second pod 122B, the third pod 122C, and the fourth pod 122D comprise plant species and/or animal species. In examples, each of the first pod 122A, the second pod 122B, the third pod 122C, and the fourth pod 122D differ in contents. For example, and as depicted in FIG. 5, the first pod 122A associated with the first quadrant 120A includes a first plant species 124A and/or a first animal species 126A, the second pod 122B associated with the second quadrant 120B includes a second plant species 124B and/or a second animal species 126B, the third pod 122C associated with the third quadrant 120C includes a third plant species 124C and/or a third animal species 126C, and the fourth pod 122D associated with the fourth quadrant 120D includes a fourth plant species 124D and/or a fourth animal species 126D. In other examples, the first pod 122A, the second pod 122B, the third pod 122C, and the fourth pod 122D share in a subset of the contents (e.g., the plant species and/or the animal species).

In examples, one or more of the first pod 122A, the second pod 122B, the third pod 122C, and the fourth pod 122D may be presented to the learner (e.g., the first learner 108) when the learner (e.g., the first learner 108) successfully demonstrates mastery tasks 156 associated with the educational skill 160 (of FIG. 3). In examples, the mastery tasks 156 may include quests, projects, competitions, and/or jobs the character must complete. Completion of the mastery tasks 156 can represent a confirmation that the target level 177 for a related education skill 175 has been achieved.

In other examples, one or more of the first pod 122A, the second pod 122B, the third pod 122C, and the fourth pod 122D may be presented to the learner (e.g., the first learner 108) when the learner (e.g., the first learner 108) enters a given quadrant and encounters the pod. For examples, the first pod 122A may be presented to the learner (e.g., the first learner 108) when the learner (e.g., the first learner 108) enters the first quadrant 120A and encounters the first pod 122A. In other examples, one or more of the first pod 122A, the second pod 122B, the third pod 122C, and the fourth pod 122D may be randomly presented to the learner (e.g., the first learner 108) when the learner (e.g., the first learner 108) advances through the online multiplayer educational game as the character.

When the learner (e.g., the first learner 108) encounters a pod (e.g., the first pod 122A) or is rewarded the pod (e.g., the first pod 122A), the learner (e.g., the first learner 108) may bring the pod (e.g., the first pod 122A) to the laboratory 140 on the vehicle 128. The laboratory 140 may have a species scanning component 188 (as shown in FIG. 7). The species scanning component 188 may receive the pod (e.g., the first pod 122A) from the learner (e.g., the first learner 108) and may reveal a subset of traits associated with the pod (e.g., the first pod 122A). In some examples, a quantity of the subset of traits associated with the pod (e.g., the first pod 122A) is three, but the quantity of the subset of traits associated with the pod (e.g., the first pod 122A) is non-limiting. The learner (e.g., the first learner 108) must then discover the remainder of the traits associated with the pod (e.g., the first pod 122A) during gameplay.

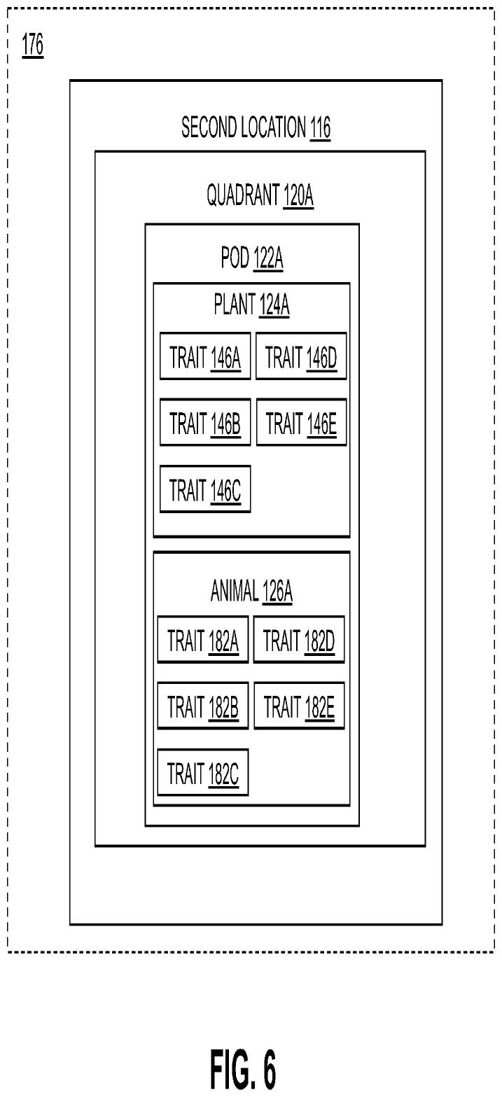

Each of the plant species and/or the animal species within the pod (e.g., the first pod 122A) may comprise traits. For example, as depicted in FIG. 6, the first pod 122A comprises the first plant species 124A and the first animal species 126A. The first plant species 124A may comprise a first trait 146A, a second trait 146B, a third trait 146C, a fourth trait 146D, and/or a fifth trait 146E, among others. The first animal species 126A may include a first trait 182A, a second trait 182B, a third trait 182C, a fourth trait 182D, and/or a fifth trait 182E, among others. Examples of these traits may include: a producer trait, a consumer trait, a predator trait, a prey trait, a cleaner trait, or a polluter trait, among others.

Subsequent receiving the quantity of the subset of traits associated with the pod (e.g., the first pod 122A), the learner (e.g., the first learner 108) must decide how the learner (e.g., the first learner 108) can foster a well-balanced ecosystem of plant and animal species on the vehicle 128, which will be transplanted and enhanced once the learner (e.g., the first learner 108) reaches the third location 118. The learner (e.g., the first learner 108) must decide whether to bring the pod (e.g., the first pod 122A) onto the vehicle 128, leave the pod (e.g., the first pod 122A) where the learner (e.g., the first learner 108) encountered it, put the pod (e.g., the first pod 122A) in the storage room/toolbox room 138 of the vehicle 128, or allocate the pod (e.g., the first pod 122A) to the hatchery/animal nursery 142 or the greenhouse 144 on the vehicle 128.

In other examples, the second location 116 or the outer space may include an advancement component 192 (of FIG. 5) that allows the learner (e.g., the first learner 108) to progress forward or backward to another quadrant, allowing for a modification of the gameplay and providing experimental shortcuts for experienced players. In an illustrative example, the advancement component 192 may be configured as a wormhole.

Once the learner (e.g., the first learner 108) traverses the second location 116 and arrives at the third location 118 or the planet, the learner (e.g., the first learner 108) must collect as much intel about this new world such that the learner (e.g., the first learner 108) designs and builds the den/dwelling (e.g., the first den 148A), as shown in FIG. 8. The learner (e.g., the first learner 108) must sustain dynamic equilibrium in the third location 118. In doing so, the learner (e.g., the first learner 108) will be asked to continually make decisions in order to find a balance between species, resources, and sometimes conflicting priorities, such as choosing if/when to expand the first den 148A with offspring. These decisions are linked to the learner's (e.g., the first learner 108) educational skill 175, target level 177, and current level 179. Various milestones of overall learning can be linked to a set of one or more target levels 177. That is, in embodiments, target levels 177 are individualized based on a specific learner 108, where milestones can be baselined differently, such as at a level of knowledge a student in grade X is expected to possess in biology, genetics, space, etc.

In embodiments, the learner (e.g., the first learner 108) must also navigate numerous factors, such as the ever-changing physical dynamics of the environs and atmosphere that produce extreme environmental fluctuations and potentially destructive, wild weather events; the presence of ominous co-inhabitants and unexpected visitors that cause colossal infestations; the persistent mind-bending and challenging impossibilities of this planet; and the looming contamination and/or depletion of a resource supply of the learner (e.g., the first learner 108).

In additional examples, randomly during gameplay, suggested dwelling/den connections may be presented to the learner (e.g., the first learner 108). For example, it may be suggested to the learner (e.g., the first learner 108) for the first learner 108 to interact with the second learner 112 associated with the second den 138B. The first learner 108 may also seek out other dwellings/dens to explore the third location 118.

As explained, during gameplay, upon detection of a successful demonstration of the training tasks 154 associated with the educational skill 160, the learner (e.g., the first learner 108) may be provided with mastery tasks 156 (of FIG. 3) associated with the educational skill 160. When a successful demonstration of the mastery tasks 156 is detected (e.g., a “YES” determination 164A of FIG. 3), the learner (e.g., the first learner 108) may be allowed to advance through the educational game as the character. The learner (e.g., the first learner 108) may also be allowed to modify one or more components in the gaming realm 176. Additionally, the learner profile 174 associated with the first learner 108 may be updated to reflect a successful completion of the mastery tasks 156 associated with the target educational skill 160.

Since the vehicle 128 is a constant measure of the level of mastery of the learner (e.g., the first learner 108) throughout gameplay, the modification of the one or more components in the gaming realm 176 may include: adding components to the vehicle 128, enhancing an efficiency of the vehicle 128, adding facilities to the vehicle 128, unlocking helpful information for game advancement, providing new crew members to the learner (e.g., the first learner 108), providing new technologies to the learner (e.g., the first learner 108) to add to the storage room/toolbox room 138 in the vehicle 128, upgrading the vehicle 128, allowing the learner (e.g., the first learner 108) to add the plant species (e.g., the first plant species 124A) and/or the animal species (e.g., the first animal species 126A) from the pod (e.g., the first pod 122A) into a room/location within the vehicle 128 (such as the storage room/toolbox room 138, the laboratory 140, the hatchery/animal nursery 142, or the greenhouse 144), and/or adding one or more resources encountered in a given quadrant into the room/location the vehicle 128 (such as the storage room/toolbox room 138, the laboratory 140, the hatchery/animal nursery 142, or the greenhouse 144), among others not explicitly listed herein. All of the tools accumulated within the vehicle 128 are applied to the creation and management of the first den 148A associated with the learner (e.g., the first learner 108).

The modification of the one or more components in the gaming realm may additionally include: adding a function of the gaming realm to the controller 162 (where each of the squares 178 represents a function of the gaming realm 176). As explained previously, the functions of the gaming realm 176 include: accumulated skills, animal species cultivated, plant species cultivated, resources, and/or management strategies, among others not explicitly listed herein. Each of these functions of the gaming realm 176 may be displayed via a visual icon (e.g., a first visual icon 180A, a second visual icon 180B, and a third visual icon 180C) on a select square of the squares 178 of the controller 162. It should be appreciated that the visual icons depicted in FIG. 4 are non-limiting and are provided for illustrative purposes only. In another example, the learner (e.g., the first learner 108) may acquire another function of the gaming realm 176 by reaching the third location 118, forming new alliances with other dwellings/dens associated with other users at the third location 118, or randomly during gameplay. In a further example, the modification of the one or more components in the gaming realm 176 may include allowing the learner (e.g., the first learner 108) to add acquired resources, plant species, and/or animal species into the den/dwelling (e.g., the first den 148A). Dwellings/dens may be a habitat of a specific species within a given ecosystem, which must be sufficiently healthy in order for such a dwelling to be utilized, per the dynamically adjusted ecology 169 experienced during gameplay.

In response to detecting a failure to demonstrate the mastery tasks 156 associated with the educational skill 160 (e.g., a “NO” response 164B as depicted in FIG. 3), the learner (e.g., the first learner 108) is provided feedback 158 (of FIG. 3) via the gaming realm 176. Moreover, the learner profile 174 is updated to reflect an unsuccessful completion of the mastery tasks 156 associated with the educational skill 160.

As explained, the online multiplayer simulation game may be played by a singular user during a given time period, such as the first learner 108. In other examples, the educational game may be played by multiple users during the given time period, such as the first learner 108 and the second learner 112. In the multiple-user scenario, a geolocation component (not shown) may be used to define in-game position of the learner (e.g., the first learner 108) such that the first learner 108 may interact with or connect with another user/learner, such as the second learner 112, when playing the multiplayer version of the game. In this multiple-user scenario, each of the learners (e.g., the first learner 108 and the second learner 112) may meet with other users/learners at one or more of the dwellings/dens in the third location 18 and may trade supplies and/or knowledge gained.

Success of the learner (e.g., the first learner 108) in the online multiplayer simulation game depends on numerous components, such as: leadership abilities of the learner (e.g., the first learner 108), data collection of the learner (e.g., the first learner 108), resource gathering of the learner (e.g., the first learner 108), decision-making of the learner (e.g., the first learner 108), construction and expansion of the dwelling/den (e.g., the first den 148A) of the learner (e.g., the first learner 108), an ability of the learner (e.g., the first learner 108) to respond to sudden disruptions, a capacity of the learner (e.g., the first learner 108) to make creative use of data collected, an ability of the learner (e.g., the first learner 108) to follow the celestial skies map 190, an ability of the learner (e.g., the first learner 108) in deciphering and making use of clues, strategic decision-making of the learner (e.g., the first learner 108), an ability of the learner (e.g., the first learner 108) to sustainably balance the built systems of the dwelling/den (e.g., the first den 148A) with the dynamic natural world (e.g., the third location 118 or the planet), and/or an ability of the learner (e.g., the first learner 108) to seek out and collaborate with other dens/dwellings on the third location 118 (e.g., the second den 138B) to collectively overcome large-scale (and devastating) natural phenomenon, planetary foes, and rapid infestations, among others. Positive gameplay achievements, such as solving clues, balancing dwellings, use of collected data, etc. can earn essence 191 in embodiments, which can be used for advancement.

### Alternate Embodiment

An alternative embodiment to the online multiplayer simulation game described herein includes an educational online multiplayer simulation game aimed to teach learners/users about the science of aerodynamics and the laws and creativity of acrobatics. Game play mechanics and visual narratives of this alternative embodiment may include graphic overlays detailing super human bodily structure and source of powers.

In this embodiment, the online multiplayer simulation game provides, via the gaming realm 176, the learner (e.g., the first learner 108) with the character (e.g., the protagonist 132) such that the learner controls the character. In this embodiment, the character (e.g., the protagonist 132) is a squirrel. The learner (e.g., the first learner 108) may navigate gameplay as the squirrel and may race against other users/learners (e.g., the second learner 112) to destinations (such as the third location 118) where food supplies and other vital resources abound.

During the journey, the learner (e.g., the first learner 108) may explore varying tree habitats that span the globe and all types of landscapes. Such tree habitats may include thriving habitats, compromised habitats, urban habitats, and/or wild habitats, among others. During travel, the learner (e.g., the first learner 108) must avoid threats, such as falling, starvation, pollution, toxic water bodies, human-placed poison traps, cars, minks, martens, skunks, ravens, magpies, eagles, owls, hawks, badgers, domesticated dogs and cats, snakes, and/or raccoons, etc., and must consume and collect food and water resources in support of their energetic needs.

### Systems, Devices and Operating Systems

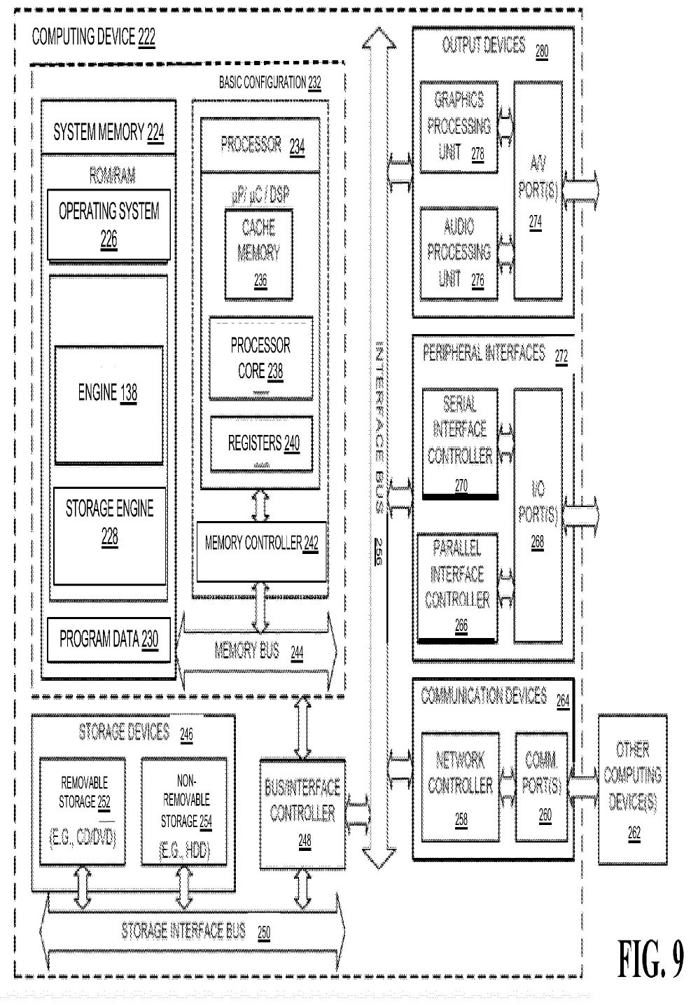

A basic configuration 232 of a computing device 222 (such as the first computing device 102 or the second computing device 104 of FIG. 1) is illustrated in FIG. 9 by those components within the inner dashed line. In the basic configuration 232 of the computing device 222, the computing device 222 includes a processor 234 and a system memory 224. The terms “processor” and “central processing unit” or “CPU” are used interchangeably herein. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (μP), a microcontroller (μC), and a digital signal processor (DSP), or any combination thereof. In examples, the microprocessor may be AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s).

Further, the processor 234 may include one more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, one or more engines, such as an engine 138, and program data 230. In some embodiments, the engine 138 may be an application, a software program, a service, or a software platform, as described infra. The system memory 224 may also include a storage engine 228 that may store any information of data disclosed herein.

The operating system 226 may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system 226 may be one specifically optimized to be run on a mobile computing device (e.g., the first computing device 102 or the second computing device 104 of FIG. 1), such as iOS, Android, Windows Phone, Tizen, Symbian, and/or the like.

As explained supra, the GUI 110 of the first computing device 102 and the second computing device 104 may provide a baseline and means of accessing and displaying information graphically to users. The GUI 110 may include Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, or Yahoo! User Interface, any of which may be used.

Additionally, a web browser component (not shown) is a stored program component that is executed by the CPU. The web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices (e.g., the first computing device 102 or the second computing device 104 of FIG. 1).

A web browser may communicate to and/or with other components in a component collection, including itself, and/or facilities of the like. Most frequently, the web browser communicates with information servers, operating systems (such as the operating system 226), integrated program components (e.g., plug-ins), and/or the like; e.g., it may contain, communicate, generate, obtain, and/or provide program component, system, user, and/or data communications, requests, and/or responses. Of course, in place of a web browser and an information server, a combined application may be developed to perform similar functions of both. The combined application would similarly affect the obtaining and the provision of information to users, user agents, and/or the like from the enabled nodes of the present invention.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 268.

Further, the one or more communication devices 264 may include a network controller 258, which is arranged to facilitate communication with one or more other computing devices 262 over a network communication link via one or more communication ports 260. The one or more other computing devices 262 include servers (such as the server 106 of FIG. 1), the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method of providing an educational game to a learner from a server, the method comprising:
detecting a connection of a computing device associated with a learner to a server;
retrieving from the server a current level of educational skill of the learner;
determining at the server a target level of educational skill of the learner;
determining at the server one or more training tasks designed to advance the current level of educational skill of the learner to the target level;
determining at the server one or more mastery tasks designed to confirm the target level of educational skill has been achieved by the learner;
providing a digital world display of a gaming realm associated with the educational game to the computing device of the learner;
providing, via the gaming realm, the learner with a character such that the learner controls actions of the character within the gaming realm, wherein the character progressing through the gaming realm includes one or more locked milestones, such that a first milestone must be unlocked prior to progression to a second milestone being enabled, wherein unlocking of the first milestone requires the learner to achieve the target level of educational skill;
providing, via the gaming realm, the determined one or more training tasks;
in response to detecting, via the gaming realm, a successful demonstration of the training tasks associated with the educational skill, providing the mastery tasks; and
in response to detecting, via the gaming realm, a successful demonstration of the mastery tasks associated with the educational skill,
unlocking the first milestone thereafter permitting the learner to process in the gaming realm towards the second milestone; and
updating the current level to the target level of educational skill of the learner.

2. The method of claim 1, further comprising:
in response to detecting a failure, via the gaming realm, to demonstrate the mastery tasks associated with the educational skill;
determining at the server one or more additional training tasks designed to advance the current level of educational skill of the learner to the target level;
providing, via the gaming realm, the determined one or more additional training tasks; and
in response to detecting, via the gaming realm, a successful demonstration of the additional training tasks associated with the educational skill, providing the mastery tasks.

3. The method of claim 1,
wherein the educational game is an online multi-player permitting the character to advance from an initial state to a more advanced state, wherein successfully demonstrating the mastery tasks associated with the educational skill progresses the character of the learner towards the more advanced state to the advantage of the character in the gaming realm contrasted with a different character in the gaming realm associated with a different learner that failed to demonstrate the master tasks assigned to the different learner.

4. The method of claim 1, further comprising:
proving essence responsive to character actions in the gaming realm, said character actions resulting in essence reflecting successful completion of at least one of the training tasks and the mastery tasks; and
permitting the character to utilize said essence in gameplay of the educational game to receive significant advantages applicable to the gaming realm.

5. The method of claim 1,
wherein the educational game is an adventure game having world building elements, wherein a post-first-milestone set of the world building elements are unlocked only after the first milestone is unlocked, wherein the character utilizing advanced ones of world building elements are dependent upon the learner successfully achieving the target educational level of the educational skill by successfully demonstrating the mastery tasks associated with the educational skill.

6. The method of claim 1,
wherein the gaming realm within which the character interacts comprises one or more biological entities, wherein the educational skill is in a field of science related to the one or more biological entities, wherein the training tasks and the mastery tasks involve interactions between the character and the gaming realm that are scientifically targeted to said field of science and a corresponding educational skill.

7. The method of claim 6, further comprising:
presenting the character in the gaming realm with a gaming realm ecology comprising said biological entities; and
detecting an interaction of the character in the gaming realm that alters the gaming realm ecology, wherein the altering of the gaming realm ecology is part of at least one of the training tasks and the mastery tasks.

8. The method of claim 7, wherein the biological entities comprise at least one animal, said method further comprising:
increasing a quantity or quality of the at least one animal responsive to an interaction of the character in the gaming realm that benefits the at least one animal within the gaming realm ecology and thereby changes the gaming realm ecology; and
permitting the character to utilize the at least one animal in gameplay of the educational game along with the increase resulting from the change in the gaming realm ecology.

9. The method of claim 7, wherein the biological entities comprise at least one plant, said method further comprising:
increasing a quantity or quality of the at least one plant responsive to an interaction of the character in the gaming realm that benefits the at least plant within the gaming realm ecology; and
permitting the character to utilize at least one plant in gameplay of the educational game along with the increase resulting from the change in the gaming realm ecology.

10. The method of claim 1, wherein the gaming realm comprises a plurality of locations within which the character interacts, wherein a first one of the locations is initially unlocked and wherein a second one of the locations is initially locked, wherein the character is restricted from gameplay interactions with the second location when locked compared to when the second location is in an unlocked state, said method further comprising:
in response to detecting, via the gaming realm, a successful demonstration of at least one of the training tasks and the mastery tasks, unlocking the second one of the locations.

11. The method of claim 1, wherein the gaming realm comprises a plurality of biological entities, each having a first trait and a second trait, wherein the first trait of the biological entities is initially unlocked and wherein the second trait is initially locked, wherein the character is restricted from gameplay interactions involving the second trait when locked compared to when the second trait is in an unlocked state, said method further comprising:
in response to detecting, via the gaming realm, a successful demonstration of at least one of the training tasks and the mastery tasks, unlocking the second trait.

12. The method of claim 1, wherein the gaming realm comprises a vehicle usable by the character during gameplay, said method further comprising:
in response to detecting, via the gaming realm, a successful demonstration of at least one of the training tasks and the mastery tasks, providing the vehicle to the character.

13. The method of claim 1, wherein the education game is a science fiction game, and wherein the character is an animal.

14. A method of providing an educational game to a learner, the method comprising:
detecting a computing device associated with a learner;
determining a target level of educational skill of the learner;
determining one or more training tasks designed to advance the learner to the target level;
providing a digital world display of a gaming realm associated with the educational game to the computing device of the learner;
providing, via the gaming realm, the learner with a character such that the learner controls actions of the character within the gaming realm, wherein the gaming realm within which the character interacts comprises one or more biological entities, wherein the educational skill is in a field of science related to the one or more biological entities, wherein the training tasks involve interactions between the character and the gaming realm that are scientifically targeted to said field of science and corresponding educational skill;
detecting, via the gaming realm, the learner with a character such that the learner controls actions of the character in gameplay within the gaming realm in a manner resulting in satisfaction of the training tasks;
responsive to satisfaction of the training tasks, recording at the server that the learner has reached the target level of the educational skill; and
responsive to the satisfaction of the training tasks, unlocking a previously locked aspect of gameplay within the gaming realm, thereby permitting the character to advance in the gameplay.

15. The method of claim 14, further comprising:
presenting the character in the gaming realm with a gaming realm ecology comprising said biological entities; and
detecting an interaction of the character in the gaming realm that alters the gaming realm ecology, wherein the altering of the gaming realm ecology is part of the training tasks.

16. The method of claim 15, wherein the biological entities comprise at least one animal, said method further comprising:
increasing a quantity or quality of the at least one animal responsive to an interaction of the character in the gaming realm that benefits the at least one animal within the gaming realm ecology and thereby changes the gaming realm ecology; and
permitting the character to utilize the at least one animal in gameplay of the educational game along with the increase resulting from the change in the gaming realm ecology.

17. The method of claim 15, wherein the biological entities comprise at least one plant, said method further comprising:
increasing a quantity or quality of the at least one plant responsive to an interaction of the character in the gaming realm that benefits the at least plant within the gaming realm ecology; and
permitting the character to utilize at least one plant in gameplay of the educational game along with the increase resulting from the change in the gaming realm ecology.

18. The method of claim 14, further comprising:
proving essence responsive to character actions in the gaming realm, said character actions resulting in essence reflecting successful completion of the training tasks; and
permitting the character to utilize said essence in gameplay of the educational game to receive significant advantages applicable to the gaming realm.

19. The method of claim 14,
wherein the educational game is an adventure game having world building elements, wherein a set of the world building elements are unlocked only after the unlocking, wherein the character utilizing advanced ones of world building elements are dependent upon the learner successfully achieving the target level of the educational skill.

20. A method of providing an educational game to a learner, the method comprising:
detecting a computing device associated with a learner;
determining one or more educational tasks designed to advance an educational skill of the learner;
providing a digital world display of a gaming realm associated with the educational game to the computing device of the learner, wherein the gaming realm has a gaming realm ecology comprising biological entities, said biological entities comprising one or more animals;
providing, via the gaming realm, the learner with a character such that the learner utilizes the character to interact with the gaming realm, said interactions occurring during gameplay, said interactions affecting the gaming realm ecology and related aspects of the biological entities, wherein the educational skill is in a field of science related to the one or more biological entities, wherein changes to the gaming realm ecology occur in a manner that advances the educational skill level of the learner;
responsive to a gameplay interaction of the character that positively affects the gaming realm ecology while concurrently advancing the educational skill level, increasing a quantity or quality of one or more animals within the gaming realm; and
permitting the character to utilize the at least one animal in gameplay of the educational game along with the increase resulting from the change in the gaming realm ecology, wherein the permitting advances the gameplay of the character.
